(19) United States
(12) Patent Application Publication
(10) Pub. No.: US 2025/0390269 A1
(43) Pub. Date: Dec. 25, 2025

(54) REDUCING LOW DROPOUT (LDO) QUIESCENT CURRENT USING DIGITAL AUDIO CONFIGURATION

(71) Applicant: QUALCOMM Incorporated, San Diego, CA (US)

(72) Inventors: Syed NASEEF, Hyderabad (IN); Bengt Stefan GUSTAVSSON, Rancho Santa Fe, CA (US)

(21) Appl. No.: 18/747,871

(22) Filed: Jun. 19, 2024

(51) Int. Cl. G06F 3/16; G05F 1/56

(52) U.S. Cl. CPC G06F 3/162; G05F 1/56

(57) ABSTRACT

Aspects of the disclosure are directed to dc power efficiency in digital audio systems. In accordance with one aspect, the disclosure includes determining an assertion time interval prior to a start of one drive bit of a plurality of drive bits based on a reconfiguration timeline; determining a de-assertion time interval subsequent to an end of the one drive bit of the plurality of drive bits based on the reconfiguration timeline; and generating a power control signal to assert a first transition to a high current state using an activation time based on the assertion time interval and to de-assert a second transition to a low current state using a passivation time based on the de-assertion time interval.

### TECHNICAL FIELD

This disclosure relates generally to the field of a multi-channel digital audio system, and, in particular, to dc power efficiency in digital audio systems with a plurality of active and passive audio peripherals.

### BACKGROUND

Digital audio systems are pervasive and are used for a variety of applications. Nearly all audio systems deliver audio information using digital signal formats for both source encoding (e.g., audio compression to reduce audio data rate) and channel encoding (e.g., error correction coding to mitigate channel errors). One type of digital audio system is a multi-channel digital audio system with a plurality of audio peripherals such as microphones, speakers, etc. The plurality of audio peripherals may be in an active state (i.e., actively transporting audio data) or may be in a passive state (i.e., enabled, but not actively transporting audio data). Current systems may include a plurality of audio peripherals in a passive state with a high quiescent current since an audio peripheral in passive state may be configured to transition quickly to an active state. The high quiescent current in the passive state translates to high dc power consumption even with no active audio data transport. Thus, there is a desire for efficient multi-channel digital audio system with a plurality of audio peripherals.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides de power efficiency in digital audio systems. Accordingly, an apparatus including: an audio peripheral configured to generate a power control signal to assert a first transition to a high current state using an activation time based on an assertion time interval and to de-assert a second transition to a low current state using a passivation time based on an de-assertion time interval; and a power supply coupled to the audio peripheral, the power supply configured to supply power to the audio peripheral.

In one example, the power supply is further configured to assert the first transition to the high current state. In one example, the power supply is further configured to de-assert the second transition to the low current state. In one example, the power supply comprises a first switch and a second switch for toggling between a low power mode and a high power mode. In one example, the apparatus further includes a power control module coupled to the power supply, the power control module configured to activate the first switch and the second switch.

In one example, the audio peripheral is further configured to determine a reconfiguration timeline from a digital audio configuration. In one example, the audio peripheral is further configured to determine the assertion time interval prior to a start of one drive bit of a plurality of drive bits based on the reconfiguration timeline and to determine the de-assertion time interval subsequent to an end of the one drive bit of the plurality of drive bits based on the reconfiguration timeline.

Another aspect of the disclosure provides a method including: determining an assertion time interval prior to a start of one drive bit of a plurality of drive bits based on a reconfiguration timeline; determining a de-assertion time interval subsequent to an end of the one drive bit of the plurality of drive bits based on the reconfiguration timeline; and generating a power control signal to assert a first transition to a high current state using an activation time based on the assertion time interval and to de-assert a second transition to a low current state using a passivation time based on the de-assertion time interval.

In one example, the assertion time interval governs a transition from a low current state to a high current state. In one example, the high current state accommodates an audio peripheral as an active load and the low current state accommodates the audio peripheral as a passive load. In one example, the de-assertion time interval governs a transition from a high current state to a low current state. In one example, the high current state accommodates an audio peripheral as an active load and the low current state accommodates the audio peripheral as a passive load.

In one example, the method further includes determining the reconfiguration timeline from a digital audio configuration. In one example, the method further includes receiving the digital audio configuration, wherein the digital audio configuration defines a transmission data frame. In one example, the digital audio configuration defines a bit slot sequence with a relative timeline of a plurality of active loads and a plurality of passive loads. In one example, the reconfiguration timeline includes a plurality of drive bits from the bit slot sequence. In one example, the bit slot sequence operates in a double data rate (DDR) mode where bit slot boundaries occur on both rising edge and falling edge of a transport clock.

Another aspect of the disclosure provides an apparatus for toggling quiescent current power mode based on a digital audio configuration, the apparatus including: means for determining an assertion time interval prior to a start of one drive bit of a plurality of drive bits based on a reconfiguration timeline; means for determining a de-assertion time interval subsequent to an end of the one drive bit of the plurality of drive bits based on the reconfiguration timeline; and means for generating a power control signal to assert a first transition to a high current state using an activation time based on the assertion time interval and to de-assert a second transition to a low current state using a passivation time based on the de-assertion time interval.

In one example, the apparatus further includes means for determining the reconfiguration timeline from the digital audio configuration. In one example, the apparatus further includes means for receiving the digital audio configuration, wherein the digital audio configuration defines a transmission data frame.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example block diagram of a digital audio system.

FIG. 2 illustrates a first example of a digital audio system peripheral subsystem.

FIG. 3 illustrates a second example of a digital audio system peripheral subsystem.

FIG. 4 illustrates a first example of a transmission data frame.

FIG. 5 illustrates an example low dropout (LDO) power supply reconfiguration timeline.

FIG. 6 illustrates a second example of a transmission data frame.

FIG. 7 illustrates a third example of a transmission data frame.

FIG. 8 illustrates a fourth example of a transmission data frame.

FIG. 9 illustrates an example drive circuit without a low power mode.

FIG. 10 illustrates an example drive circuit with a low power mode.

FIG. 11 illustrates an example flow diagram for toggling quiescent current power mode based on a digital audio configuration.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Digital audio systems are used to transport a digital audio signal from a source or a plurality of sources to a destination or a plurality of destinations. The digital audio signal may be sent to an output transducer (e.g., speaker) which converts the digital audio signal to an output acoustic signal. The digital audio signal may be received from an input transducer (e.g., microphone) which converts an input acoustic signal to the digital audio signal. One type of digital audio system is a multi-channel digital audio system with a plurality of audio peripherals such as input transducers and output transducers.

The digital audio system delivers audio information using digital signal formats for source encoding to reduce an audio data rate using audio compression. The digital signal format may also include channel encoding and interleaving to mitigate random and burst channel errors.

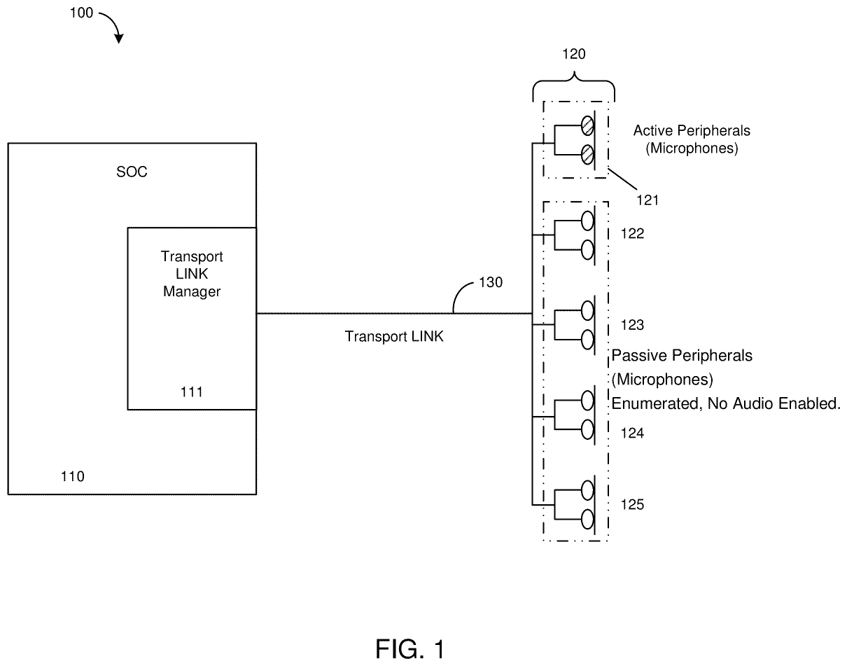

FIG. 1 illustrates an example block diagram of a digital audio system 100. The digital audio system 100 includes a system on a chip (SOC) 110 with a transport link manager 111 (e.g., SoundWire (SWR) manager). In one example, the transport link manager 111 is connected to a plurality of peripherals 120 via a transport link 130 (e.g., SoundWire link). In one example, the plurality of peripherals 120 includes an active peripheral 121 (e.g., active microphone) and a first passive peripheral 122, a second passive peripheral 123, a third passive peripheral 124 and a fourth passive peripheral 125.

In one example, the transport link 130 connects the plurality of peripherals 120 where a subset of peripherals of the plurality of peripherals 120 is in an active state (e.g., actively transporting audio data). In one example, the active peripheral 121 is in an active state and the passive peripherals 122, 123, 124 and 125 are in a passive state. In one example, the passive peripherals 122, 123, 124 and 125 are enumerated. That is, enumerated means each element of a group of elements is uniquely identified and labeled with a unique identifier.

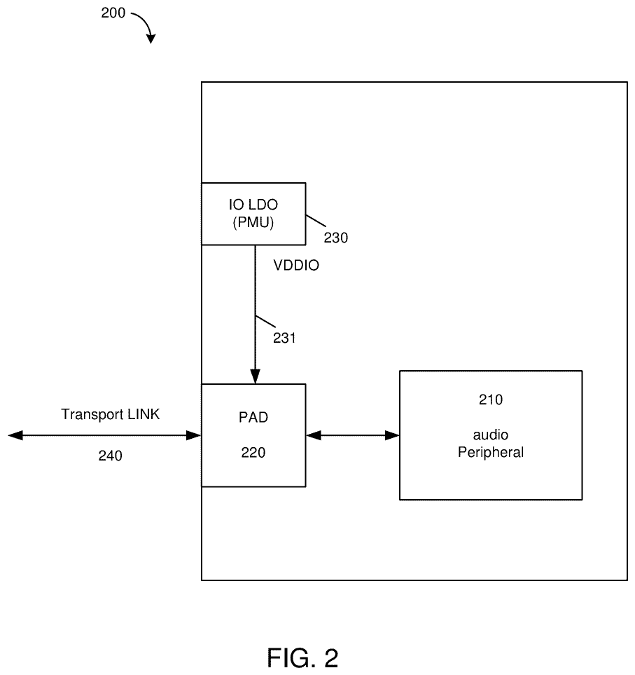

FIG. 2 illustrates a first example of a digital audio system peripheral subsystem 200. In one example, the digital audio system peripheral subsystem 200 includes an audio peripheral (e.g., microphone) 210, an output pad 220 and a low dropout (LDO) power supply 230. In one example, the digital audio system peripheral subsystem 200 receives audio data over a transport link 240 at the output pad 220 which is then delivered to the audio peripheral 210. In one example, the LDO power supply 230 provides a dc supply voltage over a first dc supply line 231 to the output pad 220. In one example, the transport link 240 conforms to the SoundWire digital audio protocol.

In one example, the output pad 220 in an input/output pad with a bidirectional port at an input terminal (e.g., a port connected to a SOC) and a plurality of output ports to drive and sample at a plurality of output terminals. In one example, the LDO power supply 230 includes a power management unit (PMU). In one example, the LDO power supply 230 provides an output voltage VDDIO to the output pad 220.

In one example, in a multi-channel digital audio system with a plurality of audio peripherals, some audio peripherals of the plurality of audio peripherals may be in an active state (i.e., actively transporting audio data) and other audio peripherals of the plurality of audio peripherals may be in a passive state (i.e., enabled and enumerated, but not actively transporting audio data). In one example, the LDO power supply 230 provides the de supply voltage which is at a lower voltage than a primary power supply. In one example, a quiescent current (i.e., current with no active load) may be at a high current state since its load may be activated (i.e., switched to active state) at any time. In one example, an audio peripheral in a passive state does not require its quiescent current at the high current state most of the time since its required duty cycle (i.e., proportion of time when in active state) may be very low (e.g., less than 10% duty cycle).

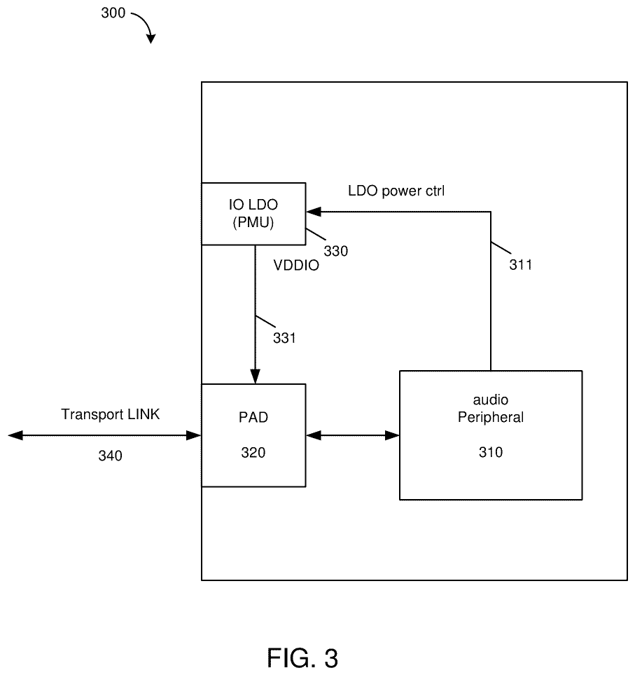

FIG. 3 illustrates a second example of a digital audio system peripheral subsystem 300. In one example, the digital audio system peripheral subsystem 300 includes an audio peripheral (e.g., microphone) 310, an output pad 320 and a low dropout (LDO) power supply 330. In one example, the digital audio system peripheral subsystem 300 receives audio data over a transport link 340 at the output pad 320 which is then delivered to the audio peripheral 310. In one example, the LDO power supply 330 provides a dc supply voltage over a second dc supply line 331 to the output pad 320. In one example, the transport link 340 conforms to the SoundWire digital audio protocol.

In one example, the digital audio system peripheral subsystem 300 includes a LDO power control signal 311 from the audio peripheral 310 to the LDO power supply 330. In one example, the LDO power control signal 311 directs the LDO power supply 330 to be in a high current state or in a low current state. In one example, the LDO power supply 330 may be in a high current state with an active load or in a low current state with a passive load. In one example, the low current state is sufficient to allow sampling of the transport link 340 state. In one example, the audio peripheral 310 may determine a plurality of activation times when a passive load transitions to an active load and a plurality of passivation times when the active load transitions to the passive load. In one example, the determination is based on a digital audio system configuration sent to the audio peripheral 310 from a system controller or host (not shown). In one example, the plurality of activation times and the plurality of passivation times may be selected based on the digital audio configuration.

In one example, the LDO power supply 330 includes an active source follower branch to provide an amplified current for the high current state. In one example, the active source follower branch is an electronic amplifier circuit which operates as a voltage buffer with a voltage gain of approximately unity and with very high input impedance and very low output impedance. For example, the active source follower branch may be implemented with a field effect transistor (FET) in a common drain topology. In one example, the high current state requires a high quiescent current for a proper drive level to an active load.

In one example, a plurality of audio peripherals in a passive state drive only a few control bit slots in a transmission data frame to signify its presence on the transport link 340 to the system controller or host. In one example, the control bit slots driven by the plurality of audio peripherals may include one or more of the following control information:
SLV_STAT_XX: indication that the peripheral (e.g., slave) is attached or may need attention
ACK, NACK: acknowledgment and negative acknowledgment
PREQ: ping request

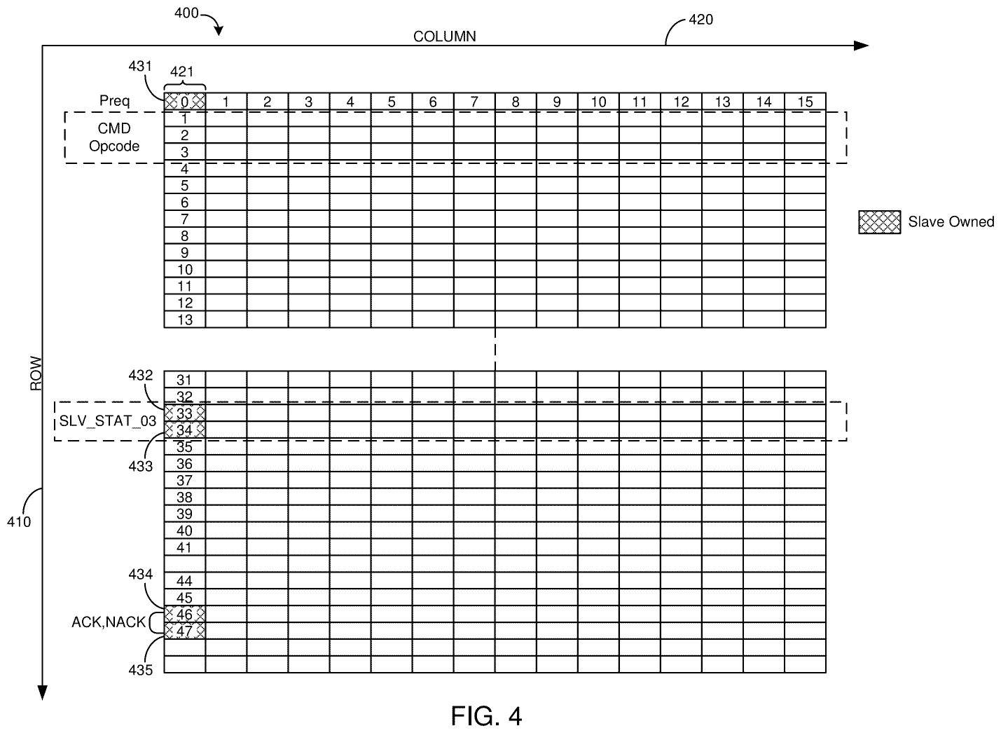

FIG. 4 illustrates a first example of a transmission data frame 400. In one example, the transmission data frame 400 is formatted as a two-dimensional data structure comprised of a plurality of bit slots with a plurality of rows 410 and a plurality of columns 420. In one example, the quantity of rows in the plurality of rows 410 is denoted as MaxRow. In one example, the quantity of columns 420 in the plurality of columns is denoted as MaxCol.

In one example, each bit slot of the plurality of bit slots of the transmission data frame 400 carries one transmission bit. In one example, a transmission bit may be either a control bit or a data bit. In one example, a control bit is part of a control word used for configuration or monitoring functions. In one example, a data bit is part of a data word used for application functions. In one example, the transmission data frame 400 may be transported as a transmission sequence as a function of time in a raster scan pattern. In one example, the raster scan pattern transmits a first row, a second row, a third row, and so forth, until a final row (i.e., indexed with MaxRow) within a frame period (i.e., reciprocal of a frame rate). In one example, each row in the plurality of rows 410 includes bit slots from each column of the plurality of columns 420. For example, for each row, the transmission order is first column, second column, third column, and so forth, until a final column (i.e., indexed with MaxCol) within a row period (i.e., time duration for transmission of each row).

In one example, FIG. 4 shows the transmission data frame 400 with a plurality of active bit slots. In one example, the plurality of active bit slots is in a first column 421 with a first active bit slot 431, a second active bit slot 432, a third active bit slot 433, a fourth active bit slot 434 and a fifth active bit slot 435. In one example, the first column 421 carries control bits only. For example, the first active bit slot 431 may carry a ping request (e.g., PREQ), the second active bit slot 432 and the third active bit slot 433 may carry an indication that the peripheral is attached or may need attention, and the fourth active bit slot 434 and the fifth active bit slot 435 may carry an acknowledgment and a negative acknowledgement. In one example, the remaining bit slots in the first example transmission data frame 400 may be passive bit slots.

In one example, the plurality of active bit slots in the transmission data frame 400 requires the LDO power supply 330 (illustrated in FIG. 3) to be in a high current state prior to arrival of each active bit slot of the plurality of bit slots.

In one example, the LDO power supply 330 may be controlled to transition from a high current state to a low current state such that its quiescent current is reduced. In one example, the transition from high current state to low current state may be mechanized by disabling a super source follower branch when a high current drive is not required (e.g., when a passive load is present). In one example, the audio peripheral 310 (illustrated in FIG. 3) receives a digital audio system configuration from a system controller or host (not shown) to select a plurality of activation times and a plurality of passivation times. In one example, the audio peripheral 310 sends the LDO power control signal 311 (illustrated in FIG. 3) to the LDO power supply 330 to select either a low current state or a high current state, based on the digital audio system configuration. In one example, the LDO power control signal 311 may be asserted (i.e., set to a high level) to select the high current state. For example, the assertion of the LDO power control signal 311 enables the super source follower branch. In one example, the LDO power control signal 311 may be de-asserted (i.e., set to a low level) to select the low current state. For example, the de-assertion of the LDO power control signal 311 disables the super source follower branch.

In one example, timing for the transition from low current state to high current state may be made configurable to assert early such that a LDO power supply reconfiguration time may be accommodated to ensure a stable high current state prior to active data transmission.

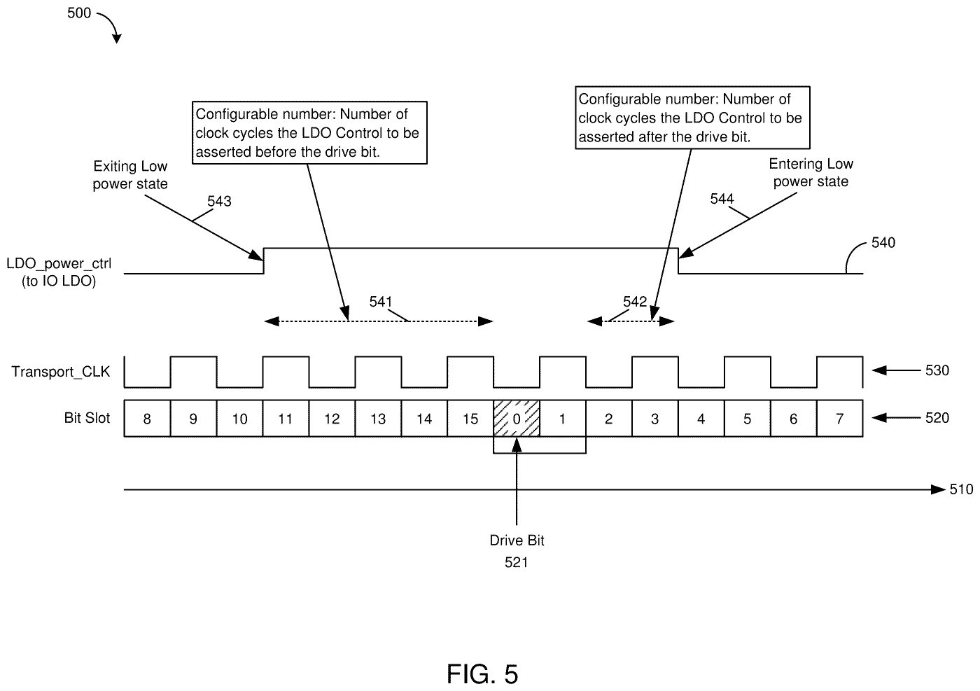

FIG. 5 illustrates an example low dropout (LDO) power supply reconfiguration timeline 500. In one example, a time axis 510 is depicted horizontally to represent a time variable. In one example, a bit slot sequence 520 includes a plurality of bit slots each indexed with an integer. In one example, a drive bit 521 is shown highlighted in the bit slot sequence 520. In one example, a transport clock (e.g., SWR clock) 530 provides a synchronous timing reference for a transport link which conveys bit slots. In one example, the transport link may operate in a double data rate (DDR) mode where bit slot boundaries occur on both rising edge and falling edge of the transport clock.

In one example, an LDO power control signal 540 from an audio peripheral controls a current state of an LDO power supply. In one example, the LDO power control signal directs the LDO power supply to be in a high current state (i.e., high power mode) or in a low current state (i.e., low power mode). In one example, the LDO power supply may be in a high current state with an active load or in a low current state with a passive load. In one example, the LDO power control signal 540 includes a first configurable time interval or assertion time interval (e.g., in transport clock cycles) 541 which specifies a first interval for the LDO power control signal 540 to be asserted prior to the start of the drive bit 521 to set the high current state.

In one example, the LDO power control signal 540 includes a second configurable time interval or de-assertion time interval (e.g., in transport clock cycles) 542 which specifies a second interval for the LDO power control signal 540 to be de-asserted subsequent to the end of the drive bit 521 to set the low current state. In one example, a first transition 543 of the LDO power control signal 540 indicates a transition from low current state to high current state. In one example, a second transition 544 of the LDO power control signal 540 indicates a transition from high current state to low current state. In one example, the first configurable time interval 541 and the second configurable time interval 542 may be based on a digital audio system configuration received by the audio peripheral from a system controller or host. In one example, the first configurable time interval 541 accommodates state transition latency in switching from low current state to high current state. In one example, the second configurable time interval accommodates state transition latency in switching from high current state to low current state.

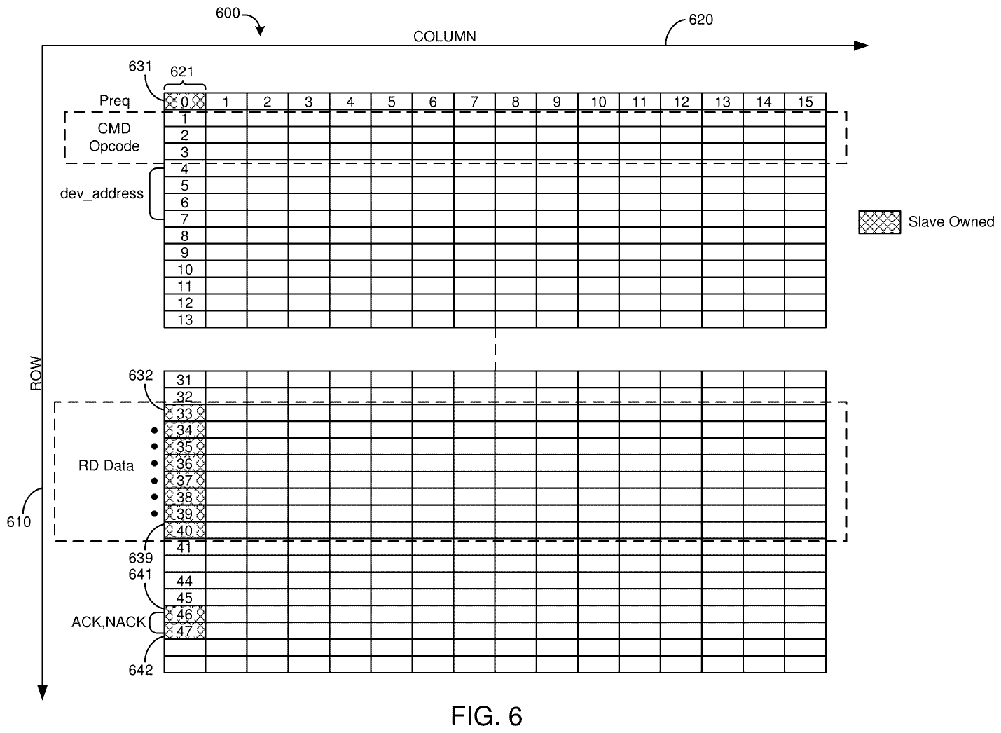

FIG. 6 illustrates a second example of a transmission data frame 600. In one example, the transmission data frame 600 is a two-dimensional data structure comprised of a plurality of bit slots with a plurality of rows 610 and a plurality of columns 620. In one example, the quantity of rows in the plurality of rows 610 is denoted as MaxRow. In one example, the quantity of columns 620 in the plurality of columns is denoted as MaxCol.

In one example, each bit slot of the plurality of bit slots of the transmission data frame 600 carries one transmission bit. In one example, a transmission bit may be either a control bit or a data bit. In one example, a control bit is part of a control word used for configuration or monitoring functions. In one example, a data bit is part of a data word used for application functions. In one example, the transmission data frame 600 may be transported as a transmission sequence as a function of time in a raster scan pattern. In one example, the raster scan pattern transmits a first row, a second row, a third row, and so forth, until a final row (i.e., indexed with MaxRow) within a frame period (i.e., reciprocal of a frame rate). In one example, each row in the plurality of rows 610 includes bit slots from each column of the plurality of columns 620. For example, for each row, the transmission order is first column, second column, third column, and so forth, until a final column (i.e., indexed with MaxCol) within a row period (i.e., time duration for transmission of each row).

In one example, the transmission data frame 600 is shown with a plurality of active bit slots. In one example, the plurality of active bit slots is in a first column 621 with a first active bit slot 631, a second active bit slot 632, a third active bit slot 633, a fourth active bit slot 634, a fifth active bit slot 635, a sixth active bit slot 636, a seventh active bit slot 637, an eighth active bit slot 638, a ninth active bit slot 639, a tenth active bit slot 641 and an eleventh active bit slot 642. In one example, the first column 621 carries control bits only. For example, the first active bit slot 631 may carry a ping request (e.g., PREQ), the second active bit slot 632, the third active bit slot 633, the fourth active bit slot 634, the fifth active bit slot 635, the sixth active bit slot 636, the seventh active bit slot 637, the eighth active bit slot 638, and the ninth active bit slot 639 may carry a read data (e.g., RD Data) command, and the tenth active bit slot 641 and the eleventh active bit slot 642 may carry an acknowledgment and a negative acknowledgement. In one example, the remaining bit slots in the second example transmission data frame 600 may be passive bit slots.

In one example, the plurality of active bit slots in the transmission data frame 600 requires the LDO power supply 330 (illustrated in FIG. 3) to be in a high current state prior to arrival of each active bit slot of the plurality of bit slots.

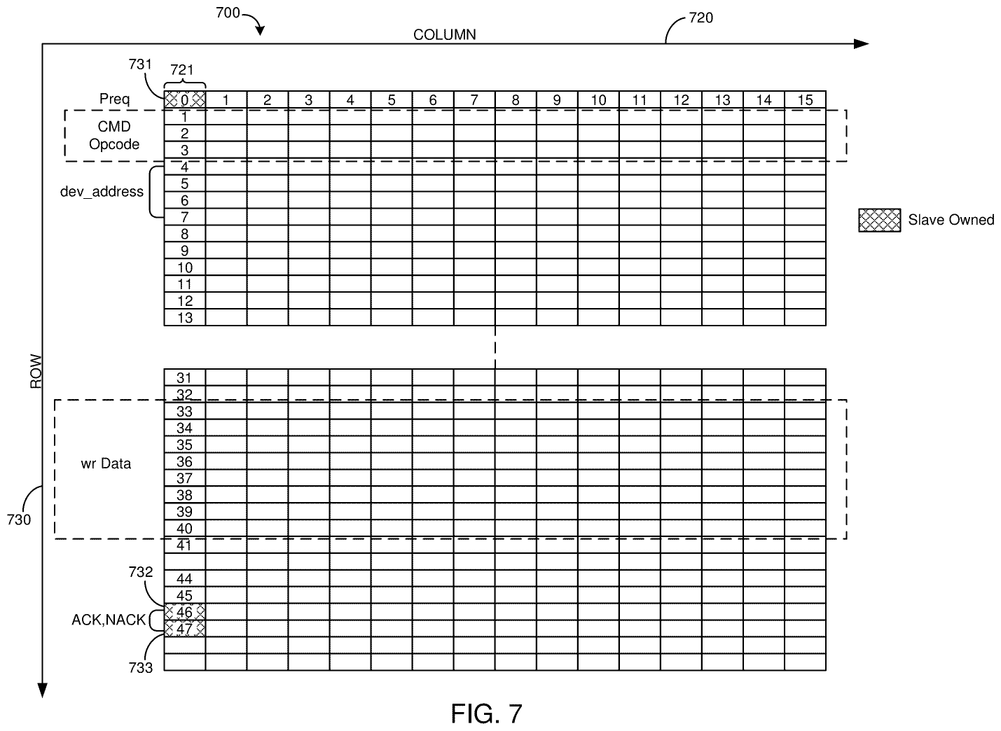

FIG. 7 illustrates a third example of a transmission data frame 700. In one example, the transmission data frame 700 is a two-dimensional data structure comprised of a plurality of bit slots with a plurality of rows 710 and a plurality of columns 720. In one example, the quantity of rows in the plurality of rows 710 is denoted as MaxRow. In one example, the quantity of columns 720 in the plurality of columns is denoted as MaxCol.

In one example, each bit slot of the plurality of bit slots of the transmission data frame 700 carries one transmission bit. In one example, a transmission bit may be either a control bit or a data bit. In one example, a control bit is part of a control word used for configuration or monitoring functions. In one example, a data bit is part of a data word used for application functions. In one example, the transmission data frame 700 may be transported as a transmission sequence as a function of time in a raster scan pattern. In one example, the raster scan pattern transmits a first row, a second row, a third row, and so forth, until a final row (i.e., indexed with MaxRow) within a frame period (i.e., reciprocal of a frame rate). In one example, each row in the plurality of rows 710 includes bit slots from each column of the plurality of columns 720. For example, for each row, the transmission order is first column, second column, third column, and so forth, until a final column (i.e., indexed with MaxCol) within a row period (i.e., time duration for transmission of each row).

In one example, the transmission data frame 700 is illustrated with a plurality of active bit slots. In one example, the plurality of active bit slots is in a first column 721 with a first active bit slot 731, a second active bit slot 732, and a third active bit slot 733. In one example, the first column 721 carries control bits only. For example, the first active bit slot 731 may carry a ping request (e.g., PREQ), the second active bit slot 732 and the third active bit slot 733 may carry an acknowledgment and a negative acknowledgement. In one example, the remaining bit slots in the transmission data frame 700 may be passive bit slots.

In one example, the plurality of active bit slots in the third example transmission data frame 700 requires the LDO power supply 330 (illustrated in FIG. 3) to be in a high current state prior to arrival of each active bit slot of the plurality of bit slots.

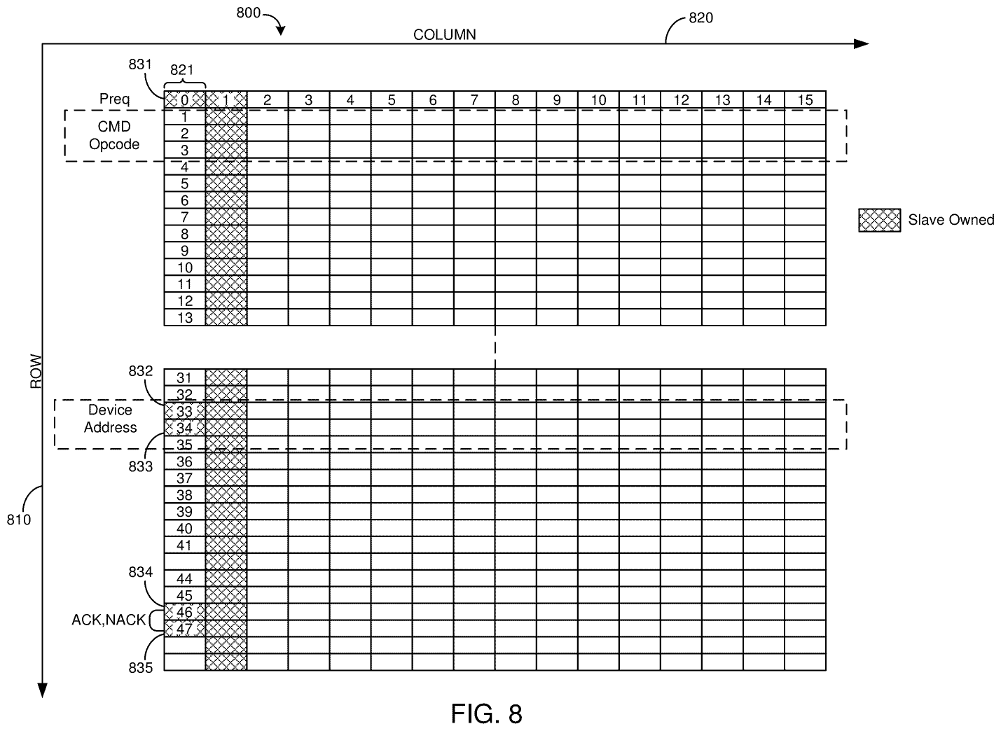

FIG. 8 illustrates a fourth example of a transmission data frame 800. In one example, the transmission data frame 800 is a two-dimensional data structure comprised of a plurality of bit slots with a plurality of rows 810 and a plurality of columns 820. In one example, the quantity of rows in the plurality of rows 810 is denoted as MaxRow. In one example, the quantity of columns 820 in the plurality of columns is denoted as MaxCol.

In one example, each bit slot of the plurality of bit slots of the transmission data frame 800 carries one transmission bit. In one example, a transmission bit may be either a control bit or a data bit. In one example, a control bit is part of a control word used for configuration or monitoring functions. In one example, a data bit is part of a data word used for application functions. In one example, the transmission data frame 800 may be transported as a transmission sequence as a function of time in a raster scan pattern. In one example, the raster scan pattern transmits a first row, a second row, a third row, and so forth, until a final row (i.e., indexed with MaxRow) within a frame period (i.e., reciprocal of a frame rate). In one example, each row in the plurality of rows 810 includes bit slots from each column of the plurality of columns 820. For example, for each row, the transmission order is first column, second column, third column, and so forth, until a final column (i.e., indexed with MaxCol) within a row period (i.e., time duration for transmission of each row).

In one example, the transmission data frame 800 is illustrated with a plurality of active bit slots. In one example, the plurality of active bit slots is in a first column 821 with a first active bit slot 831, a second active bit slot 832, a third active bit slot 833, a fourth active bit slot 834 and a fifth active bit slot 835. In one example, the first column 821 carries control bits only. For example, the first active bit slot 831 may carry a ping request (e.g., PREQ), the second active bit slot 832 and the third active bit slot 833 may carry a device address, and the fourth active bit slot 834 and the fifth active bit slot 835 may carry an acknowledgment and a negative acknowledgement. In one example, the remaining bit slots in the transmission data frame 800 may be passive bit slots.

In one example, the plurality of active bit slots in the transmission data frame 800 requires the LDO power supply 330 (illustrated in FIG. 3) to be in a high current state prior to arrival of each active bit slot of the plurality of bit slots.

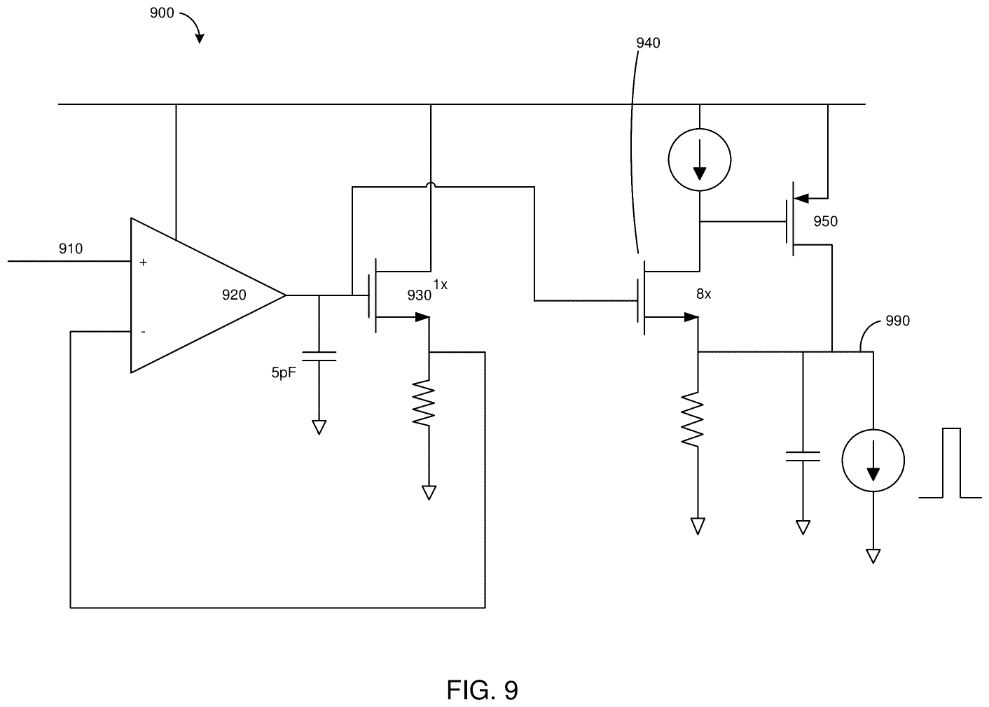

FIG. 9 illustrates an example drive circuit 900 without a low power mode. In one example, the first example drive circuit 900 is configured with a super source follower branch to provide a high current drive to an output pad which drives an audio peripheral. In one example, the first example drive circuit 900 operates as a unity gain voltage amplifier between input 910 and output 990 with a high input impedance and a low output impedance. In one example, the first example drive circuit 900 includes an operational amplifier 920, a first field effect transistor (FET) 930, a second FET 940 and a third FET 950.

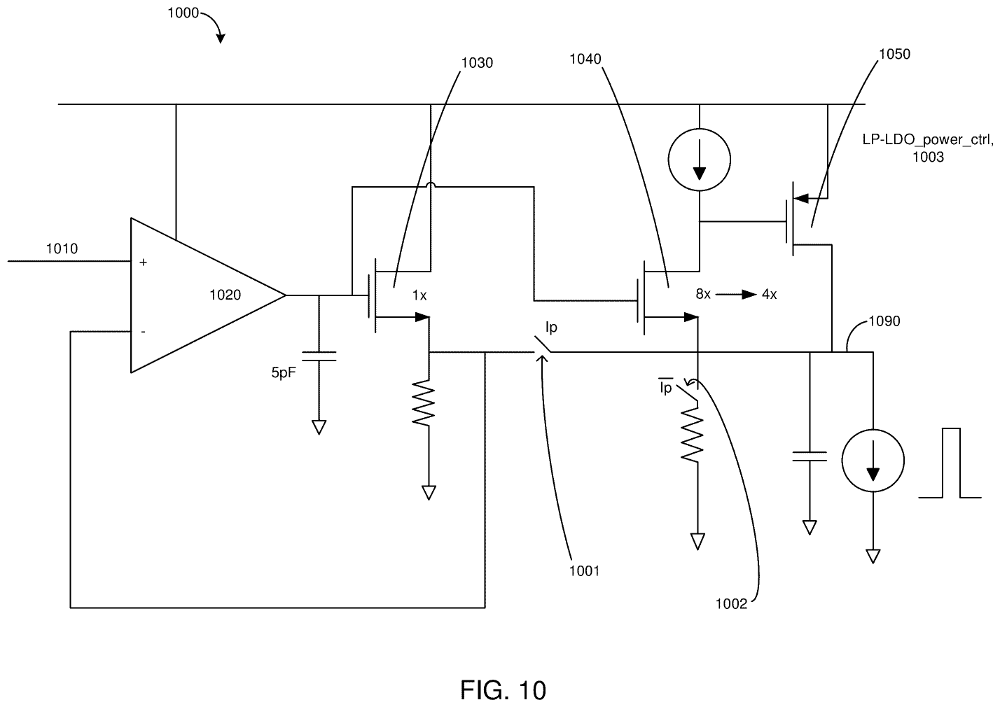

FIG. 10 illustrates an example drive circuit 1000 with a low power mode. In one example, the second example drive circuit 1000 is configured with a super source follower branch to provide a high current drive to an output pad which drives an audio peripheral. In one example, the second example drive circuit 1000 operates as a unity gain voltage amplifier between input 1010 and output 1090 with a high input impedance and a low output impedance. In one example, the drive circuit 1000 includes an operational amplifier 1020, a first field effect transistor (FET) 1030, a second FET 1040 and a third FET 1050.

In one example, the drive circuit 1000 also includes a first switch 1001 and a second switch 1002 to disengage the super source follower branch when a LDO power control signal 1003 is de-asserted (i.e., set to a low level). In one example, the LDO power control signal 1003 is controlled by the audio peripheral being driven according to a digital audio system configuration. In one example, the LDO power control signal 1003 is received by a power control module (not shown). In one example, the power control module activates the first switch 1001 and/or the second switch 1002.

In one example, the audio peripheral may determine a plurality of activation times when a passive load transitions to an active load and a plurality of passivation times when the active load transitions to the passive load. In one example, the determination is based on a digital audio system configuration sent to the audio peripheral from a system controller or host. In one example, the plurality of activation times and the plurality of passivation times may be selected based on the digital audio configuration.

In one example, the drive circuit 1000 is only one example circuit which may be configured to be toggled between a low power mode and a high power mode according to the digital audio configuration. In one example, the low power mode is more power efficient when the audio peripheral is a passive load. In one example, the high power mode provides high quiescent current when the audio peripheral is an active load.

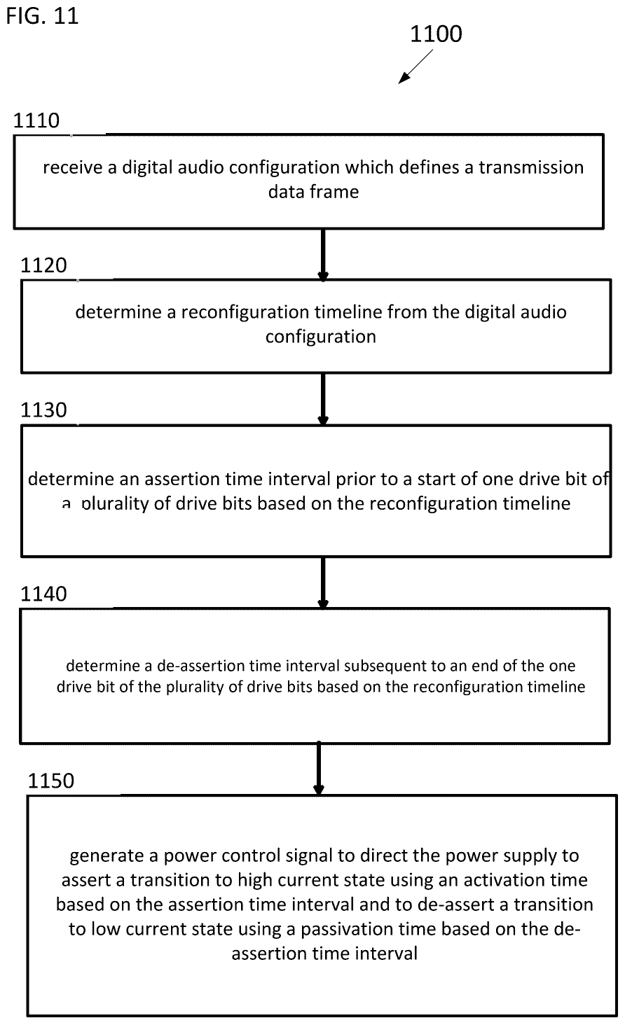

FIG. 11 illustrates an example flow diagram 1100 for toggling quiescent current power mode based on a digital audio configuration. In block 1110, receive a digital audio configuration which defines a transmission data frame. In one example, a digital audio configuration which defines a transmission data frame is received. In one example, an audio peripheral receives the digital audio configuration. In another example, the digital audio configuration is received by an interface circuit or an input circuit of the audio peripheral. In another example, the digital audio configuration is received by a processor or a microcontroller. In one example, the digital audio configuration is received by an interface circuit or an input circuit of a processor or of a microcontroller.

In one example, the transmission data frame is formatted as a two-dimensional data structure comprised of a plurality of bit slots. In one example, the transmission data frame includes a plurality of rows and a plurality of columns. In one example, the transmission data frame is conveyed on a transport link from a system controller or host. In one example, the digital audio configuration is received by an audio peripheral (e.g., speaker, microphone, etc.) from a system controller or host.

In block 1120, determine a reconfiguration timeline from the digital audio configuration. In one example, a reconfiguration timeline is determined from the digital audio configuration. In one example, the digital audio configuration defines a bit slot sequence with a relative timeline of a plurality of active loads and a plurality of passive loads. In one example, the reconfiguration timeline includes a plurality of drive bits from the bit slot sequence. In one example, the plurality of drive bits defines the relative timeline of the plurality of active loads. In one example, the plurality of active loads requires a power supply to be in a high current state to drive an active load. In one example, the active load is the audio peripheral. In one example, the reconfiguration timeline is synchronized by a transport clock from the system controller or host. In one example, the bit slot sequence operates in a double data rate (DDR) mode where bit slot boundaries occur on both rising edge and falling edge of the transport clock. In one example, the determination of the reconfiguration timeline is performed by the audio peripheral. In another example, the determination of the reconfiguration timeline is performed by a processor or a microcontroller.

In block 1130, determine an assertion time interval prior to a start of one drive bit of a plurality of drive bits based on the reconfiguration timeline. In one example, an assertion time interval prior to a start of one drive bit of a plurality of drive bits is determined based on the reconfiguration timeline. In one example, the assertion time interval governs a transition from low current state to high current state. In one example, the assertion time interval is specified in units of transport clock cycles. In one example, the assertion time interval accommodates state transition latency in switching from low current state to high current state. In one example, the determination of the assertion time interval is performed by the audio peripheral. In another example, the determination of the assertion time interval is performed by a processor or a microcontroller.

In block 1140, determine a de-assertion time interval subsequent to an end of the one drive bit of the plurality of drive bits based on the reconfiguration timeline. In one example, a de-assertion time interval subsequent to an end of the one drive bit of the plurality of drive bits is determined based on the reconfiguration timeline. In one example, the de-assertion time interval governs a transition from high current state to low current state. In one example, the de-assertion time interval is specified in units of transport clock cycles. In one example, the de-assertion time interval accommodates state transition latency in switching from high current state to low current state. In one example, the determination of the de-assertion time interval is performed by the audio peripheral. In another example, the determination of the de-assertion time interval is performed by a processor or a microcontroller.

In block 1150, generate a power control signal to direct the power supply to assert a transition to high current state using an activation time based on the assertion time interval and to de-assert a transition to low current state using a passivation time based on the de-assertion time interval. In one example, a power control signal is generated to direct the power supply to assert a transition to high current state using an activation time based on the assertion time interval and to de-assert a transition to low current state using a passivation time based on the de-assertion time interval. In one example, the power control signal is generated by an audio peripheral. In another example, the power control signal is generated by a power control module.

In one example, the high current state in the power supply accommodates the audio peripheral as an active load. In one example, the low current state in the power supply accommodates the audio peripheral as a passive load. In one example, the power control signal is generated by the audio peripheral based on the reconfiguration timeline and sent to the power supply.

In one aspect, one or more of the steps for providing toggling quiescent current power mode based on a digital audio configuration in FIG. 11 may be executed by one or more processors which may include hardware, software, firmware, etc. The one or more processors, for example, may be used to execute software or firmware needed to perform the steps in the flow diagram of FIG. 11. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
an audio peripheral configured to generate a power control signal to assert a first transition to a high current state using an activation time based on an assertion time interval and to de-assert a second transition to a low current state using a passivation time based on an de-assertion time interval; and
a power supply coupled to the audio peripheral, the power supply configured to supply power to the audio peripheral.

2. The apparatus of claim 1, wherein the power supply is further configured to assert the first transition to the high current state.

3. The apparatus of claim 1, wherein the power supply is further configured to de-assert the second transition to the low current state.

4. The apparatus of claim 1, wherein the power supply comprises a first switch and a second switch for toggling between a low power mode and a high power mode.

5. The apparatus of claim 4, further comprising a power control module coupled to the power supply, the power control module configured to activate the first switch and the second switch.

6. The apparatus of claim 5, wherein the audio peripheral is further configured to determine a reconfiguration timeline from a digital audio configuration.

7. The apparatus of claim 6, wherein the audio peripheral is further configured to determine the assertion time interval prior to a start of one drive bit of a plurality of drive bits based on the reconfiguration timeline and to determine the de-assertion time interval subsequent to an end of the one drive bit of the plurality of drive bits based on the reconfiguration timeline.

8. A method comprising:
determining an assertion time interval prior to a start of one drive bit of a plurality of drive bits based on a reconfiguration timeline;
determining a de-assertion time interval subsequent to an end of the one drive bit of the plurality of drive bits based on the reconfiguration timeline; and
generating a power control signal to assert a first transition to a high current state using an activation time based on the assertion time interval and to de-assert a second transition to a low current state using a passivation time based on the de-assertion time interval.

9. The method of claim 8, wherein the assertion time interval governs a transition from a low current state to a high current state.

10. The method of claim 9, wherein the high current state accommodates an audio peripheral as an active load and the low current state accommodates the audio peripheral as a passive load.

11. The method of claim 8, wherein the de-assertion time interval governs a transition from a high current state to a low current state.

12. The method of claim 11, wherein the high current state accommodates an audio peripheral as an active load and the low current state accommodates the audio peripheral as a passive load.

13. The method of claim 8, further comprising determining the reconfiguration timeline from a digital audio configuration.

14. The method of claim 13 further comprising receiving the digital audio configuration, wherein the digital audio configuration defines a transmission data frame.

15. The method of claim 14 wherein the digital audio configuration defines a bit slot sequence with a relative timeline of a plurality of active loads and a plurality of passive loads.

16. The method of claim 15, wherein the reconfiguration timeline includes a plurality of drive bits from the bit slot sequence.

17. The method of claim 15, wherein the bit slot sequence operates in a double data rate (DDR) mode where bit slot boundaries occur on both rising edge and falling edge of a transport clock.

18. An apparatus for toggling quiescent current power mode based on a digital audio configuration, the apparatus comprising:
means for determining an assertion time interval prior to a start of one drive bit of a plurality of drive bits based on a reconfiguration timeline;
means for determining a de-assertion time interval subsequent to an end of the one drive bit of the plurality of drive bits based on the reconfiguration timeline; and
means for generating a power control signal to assert a first transition to a high current state using an activation time based on the assertion time interval and to de-assert a second transition to a low current state using a passivation time based on the de-assertion time interval.

19. The apparatus of claim 18, further comprising means for determining the reconfiguration timeline from the digital audio configuration.

20. The apparatus of claim 19, further comprising means for receiving the digital audio configuration, wherein the digital audio configuration defines a transmission data frame.
